(19) United States
(12) Patent Application Publication
(10) Pub. No.: US 2005/0116904 A1
(43) Pub. Date: Jun. 2, 2005

(54) Drive device and drive method of light emitting display panel

(75) Inventor: Shinobu Adachi, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 10/983,570

(22) Filed: Nov. 9, 2004

(30) Foreign Application Priority Data
Nov. 28, 2003 (JP) 2003-399126

(51) Int. Cl. G09G 3/30

(52) U.S. Cl. 345/76

(57) ABSTRACT

In order to realize current drive type gradation control accompanied by γ correction without enlarging the circuit scale, for example, a light emittable period of light emitting elements during one scan period is time-divided into two periods of a first half and a latter half to execute a light emission drive operation of the light emitting elements. For example, during the first half period, a light emission drive current given to the light emitting elements is generated by a current mirror circuit 16, utilizing intensity conversion data read out of a γ correction data table 12. During the latter half period, the light emission drive current given to the light emitting elements is generated by the same current mirror circuit 16, utilizing intensity conversion data read out of a display data table 11. When a mean value of intensities of the light emitting elements during the light emittable period is produced, gradation expression accompanied by γ correction can be realized.

### BACKGROUND OF THE INVENTION

1. Field of the Invention

The present invention relates to a drive device aimed at a passive matrix type display panel in which for example organic. EL (electroluminescent) elements are employed as light emitting elements, and particularly to a drive device and a drive method of a light emitting display panel which realizes current drive type gradation control including γ (luminance response) correction without increasing the circuit scale.

2. Description of the Related Art

A display panel constructed by arranging light emitting elements in a matrix pattern has been developed widely, and as the light emitting element employed in such a display panel, for example, an organic EL element in which an organic material is employed in a light emitting layer has attracted attention. This is because of backgrounds one of which is that by employing, in the light emitting layer of the element, an organic compound which enables an excellent light emission characteristic to be expected, a high efficiency and a long life which can be equal to practical use have been advanced.

The organic EL element can be electrically replaced by a structure composed of a light emitting component having a diode characteristic and a parasitic capacitance component which is connected in parallel to this light emitting component, and it can be said that the organic EL element is a capacitive light emitting element. When a light emission drive voltage is applied to this organic EL element, at first, electrical charges corresponding to the electric capacity of this element flow into the electrode as displacement current and are accumulated. It can be considered that when the light emission drive voltage then exceeds a predetermined voltage (light emission threshold voltage=Vth) peculiar to this element, current begins to flow from one electrode (anode side of the diode component) to an organic layer constituting the light emitting layer so that the element emits light at an intensity proportional to this current.

Meanwhile, regarding the organic EL element, due to reasons that the voltage-intensity characteristic thereof is unstable with respect to temperature changes while the current-intensity characteristic thereof is stable with respect to temperature changes and that degradation of the organic EL element is considerable when the organic EL element receives excess current so that the light emission lifetime is shortened, and the like, a constant current drive is performed generally. A passive drive type display panel employing such organic EL elements has already been put into practical use partly.

As gradation control methods of the passive drive type display panel, time gradation method in which light emission time during each scan period is controlled to obtain a predetermined gradation and current gradation method in which drive current given to a light emitting element during each scan period is controlled to obtain a predetermined gradation have been proposed. Although any of the gradation control methods has advantages and shortcomings respectively, specifically the latter current gradation method has been said to be able to prolong the lifetime of the EL element generally compared to the case where the time gradation method is adopted. The reason is that while control in which an approximately maximum drive current flows is performed at a light emission time of the EL element in the case where the time gradation method is adopted, a chance that a maximum drive current flows rarely occurs in the case of the current gradation method.

Here, in the case where the latter current gradation method is adopted, it is relatively easy to linearly control the drive current value given to the light emitting element in response to gradation. In this case, for example, a plurality of resistors which have the same resistance value are connected in series or the like to construct so-called ladder resistors so as to draw electrical potentials of respective connection points so that the drive current generated based on these potentials is supplied to the light emitting elements.

However, in the case where current gradation including γ correction is to be realized with the above-described structure, the above-described relatively simple structure cannot satisfy the current gradation including γ correction, and a problem that the circuit scale thereof is considerably large occurs for the following reasons.

That is, FIG. 1 shows one example of a γ correction curve which is suitably adopted in the case where this type of EL element is employed, where the horizontal axis represents gradation and the vertical axis represents light emission intensity. That having been said, an intensity characteristic with respect to ideal gradation in the case where the EL element is employed is based on a correction curve of the order of γ=1.8 to 2.0.

As understood from the γ correction curve exemplified in this FIG. 1, it is necessary to allow light emission intensity differences for each gradation to be considerably small in a low gradation side and to allow light emission intensity differences for each gradation to be large in a high gradation side. Accordingly, since it is necessary to finely control light emission intensity differences for each gradation particularly in a low gradation side, in the case where this is to be realized in the structure of the aforementioned ladder resistors, it becomes necessary to device means in which a large number of resistors which have slightly different resistance values are prepared so that these resistors, for example, are serial-parallel combined or the like. In that case, a case where switching transistors or the like for performing switching control for the serial-parallel connection relationship are needed may occur, and thus such a circuit structure has to be complex and large-scaled. Further, in the case where a user needs to change a γ correction characteristic, the respective resistors have to be variable.

In order to avoid the above-described problems, means may be considered wherein the ladder resistors are made relatively simple and a DAC (digital to analog converter) prepared to extract voltage outputs from the ladder resistors is allowed to have a γ correction characteristic. However, in the case where such means is employed, another problem that the control bit number of the DAC has to be large occurs.

Thus, avoiding the ladder resistor combination and the DAC which is allowed to have γ correction means as described above, a current mirror circuit generating drive current values given to light emitting elements based on the output of the DAC is allowed to have the function of a γ correction characteristic. This means is disclosed in Japanese Patent Application Laid-Open No. 2003-288051.

In a γ correction circuit disclosed in the Japanese Patent Application Laid-Open No. 2003-288051, a load resistor of the current mirror circuit is allowed to be variable so that the drive current given to light emitting elements is controlled, thereby providing a γ characteristic. However, in specific γ correction means disclosed in Japanese Patent Application Laid-Open No. 2003-288051, in order to vary the load resistor of the current mirror circuit, a large number of resistors (ladder resistors) and a DAC controlled by several bits are employed together, and the basic structure thereof does not substantially differ from the one in which the ladder resistors and the DAC are combined.

In the case where a user needs to change a γ correction characteristic, even in the structure disclosed in Japanese Patent Application Laid-Open No. 2003-288051, a variable resistor or the like has to be prepared separately, and this problem is similar to that of the above-described conventional example.

### SUMMARY OF THE INVENTION

The present invention has been developed as attention to the above-described technical problems has been paid, and it is an object of the present invention to provide a drive device and a drive method of a light emitting display panel in which the current gradation method in which the value of drive current given to light emitting elements during each scan period is controlled to obtain a predetermined gradation is adopted so as to realize γ correction with sufficient accuracy for practical use without enlarging the circuit scale.

A preferred first form of a drive device of a light emitting display panel according to the present invention which has been developed to solve the problems is a drive device of a passive matrix type light emitting display panel comprising a plurality of data lines and a plurality of scan lines which intersect one another and light emitting elements which are respectively connected between the respective data lines and scan lines at intersection positions between the respective data lines and scan lines, characterized by being constructed in such a way that one scan period is time-divided into a plurality of periods, that a drive current supplied to the light emitting elements is controlled for each of the plural periods to execute light emission control of the light emitting elements for each of the periods, and that gradation control including γ correction is performed by a mean value of light emission intensities of the light emitting elements during the one scan period.

A preferred second form of a drive device of a light emitting display panel according to the present invention is a drive device of a passive matrix type light emitting display panel comprising a plurality of data lines and a plurality of scan lines which intersect one another and light emitting elements which are respectively connected between the respective data lines and scan lines at intersection positions between the respective data lines and scan lines, characterized by being constructed in such a way that for each of plural frame periods or of plural subframe periods, a drive current supplied to the light emitting elements is controlled to execute light emission control of the light emitting elements for each said period, and that gradation control including γ correction is performed by a mean value of light emission intensities of the light emitting elements during the plural frame periods or the plural subframe periods.

A preferred first form of a drive method of a light emitting display panel according to the present invention which has been developed to solve the problems is a drive method of a passive matrix type light emitting display panel comprising a plurality of data lines and a plurality of scan lines which intersect one another and light emitting elements which are respectively connected between the respective data lines and scan lines at intersection positions between the respective data lines and scan lines, characterized in that one scan period is time-divided into a plurality of periods, that intensity conversion data from data tables which are set corresponding to said periods are obtained during each period, and that a process in which a light emission drive current based on the obtained intensity conversion data is added to the light emitting elements is executed sequentially, so that gradation control including γ correction is realized by a mean value of light emission intensities by the light emitting elements during the one scan period.

Further, a preferred second form of a drive method of a light emitting display panel according to the present invention is a drive method of a passive matrix type light emitting display panel comprising a plurality of data lines and a plurality of scan lines which intersect one another and light emitting elements which are respectively connected between the respective data lines and scan lines at intersection positions between the respective data lines and scan lines, characterized in that for each of plural frame periods or of plural subframe periods, intensity conversion data from data tables which are set corresponding to said periods are obtained, and that a process in which a light emission drive current based on the obtained intensity conversion data is added to the light emitting elements is executed sequentially, so that gradation control including γ correction is realized by a mean value of light emission intensities by the light emitting elements during the plural frame periods or plural subframe periods.

### BRIEF DESCRIPTION OF THE DRAWINGS

FIG. 1 is a characteristic view showing one example of a γ correction curve suitably adopted in the case where organic EL elements are employed;

FIG. 2 is a connection diagram showing a passive drive type display panel to which the present invention is applied and a basic structure of a drive device thereof;

FIG. 3 is a block diagram showing a first embodiment according to the present invention which realizes gradation control of a current drive method;

FIG. 4 is a timing chart explaining operations of the structure shown in FIG. 3;

FIG. 5 is a connection diagram showing one preferred example of a display DAC utilized in the structure shown in FIG. 3;

FIG. 6 is a connection diagram showing a preferred one example of a current mirror circuit utilized in the structure shown in FIG. 3;

FIG. 7 is a table formation showing an example of stored data employed for realizing gradation control accompanied by γ correction;

FIG. 8 is a table formation showing another example of stored data similarly;

FIG. 9 is a block diagram showing a second embodiment according to the present invention which realizes gradation control of the current drive method; and

FIG. 10 is a timing chart explaining operations of the structure shown in FIG. 9.

### DESCRIPTION OF THE PREFERRED EMBODIMENTS

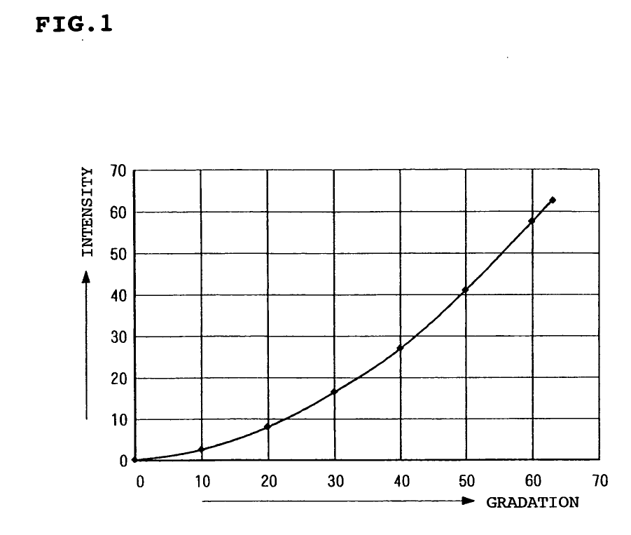

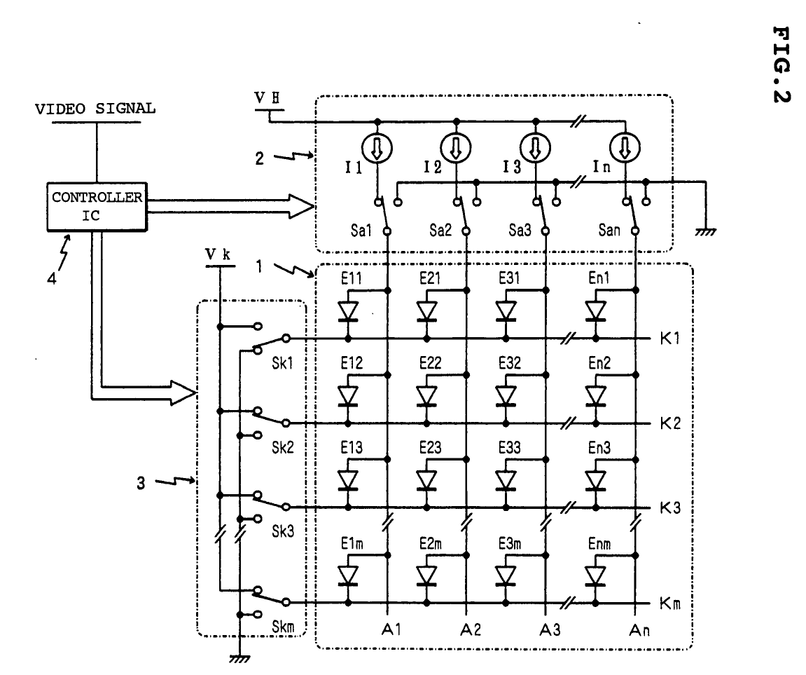

A drive device of a light emitting display panel according to the present invention will be described below with reference to the embodiments shown in the drawings. First, FIG. 2 shows a passive drive type display panel to which the present invention is applied and a basic structure of a drive device of the display panel. There are two drive methods for organic EL elements in this passive matrix drive system, that is, cathode line scan/anode line drive and anode line scan/cathode line drive, and the structure shown in FIG. 1 shows a form of the former cathode line scan/anode line drive.

That is, anode lines A1-An as n data lines are arranged in a vertical direction, cathode lines K1-Km as m scan lines are arranged in a horizontal direction, and organic EL elements E11-Enm designated by symbols/marks of diodes are arranged at portions at which the anode lines intersect the cathode lines (in total, n×m portions) to construct a display panel 1.

In the respective EL elements E11-Enm constituting pixels, one ends thereof (anode terminals in equivalent diodes of EL elements) are connected to the anode lines and the other ends thereof (cathode terminals in equivalent diodes of EL elements) are connected to the cathode lines, corresponding to respective intersection positions between the anode lines A1-An extending along the vertical direction and the cathode lines K1-Km extending along the horizontal direction. Further, the respective anode lines A1-An are connected to an anode line drive circuit 2 provided as a data driver, and the respective cathode lines K1-Km are connected to a cathode line scan circuit 3 provided as a scan driver, so as to be driven respectively.

The anode line drive circuit 2 is provided with constant current sources I1-In which utilize a drive voltage VH to be operated and drive switches Sa1-San, and the drive switches Sa1-San are connected to the constant current sources I1-In side so that current from the constant current sources I1-In is supplied to the respective EL elements E11-Enm arranged corresponding to the cathode lines as drive current. When current from the constant current sources I1-In is not supplied to the respective EL elements, the drive switches Sa1-San can allow these anode lines to be connected to a ground side provided as a reference potential point.

Meanwhile, the cathode line scan circuit 3 is equipped with scan switches Sk1-Skm corresponding to the respective cathode lines K1-Km, and these scan switches operate to allow either a reverse bias voltage Vk constituted by a predetermined direct current voltage for mainly preventing cross talk light emission or the ground potential provided as the reference potential point to be connected to corresponding cathode lines. Thus, the constant current sources I1-In are connected to desired anode lines A1-An while the respective cathode lines are sequentially set at the reference potential point (ground potential) at a predetermined cycle, so that the respective EL elements can be selectively illuminated.

A bus line is connected from a controller IC 4 including a CPU to the anode line drive circuit 2 and the cathode line scan circuit 3, and switching operations of the scan switches Sk1-Skm and the drive switches Sa1-San are performed based on a video signal to be displayed. Thus, the constant current sources I1-In are connected to desired anode lines while the cathode scan lines are set to the ground potential at a predetermined cycle based on the video signal as described above, and the respective light emitting elements are selectively illuminated so that an image based on the video signal is displayed on the display panel 1.

In the state shown in FIG. 2, the first cathode line K1 is set to the ground potential to be in a scan state, and at this time, the reverse bias voltage Vk is applied to the respective cathode lines K2-Km which are in a non-scan state. Thus, the respective EL elements connected at the intersections between a driven anode line and the cathode lines which are not selected for scanning are prevented from emitting cross talk light.

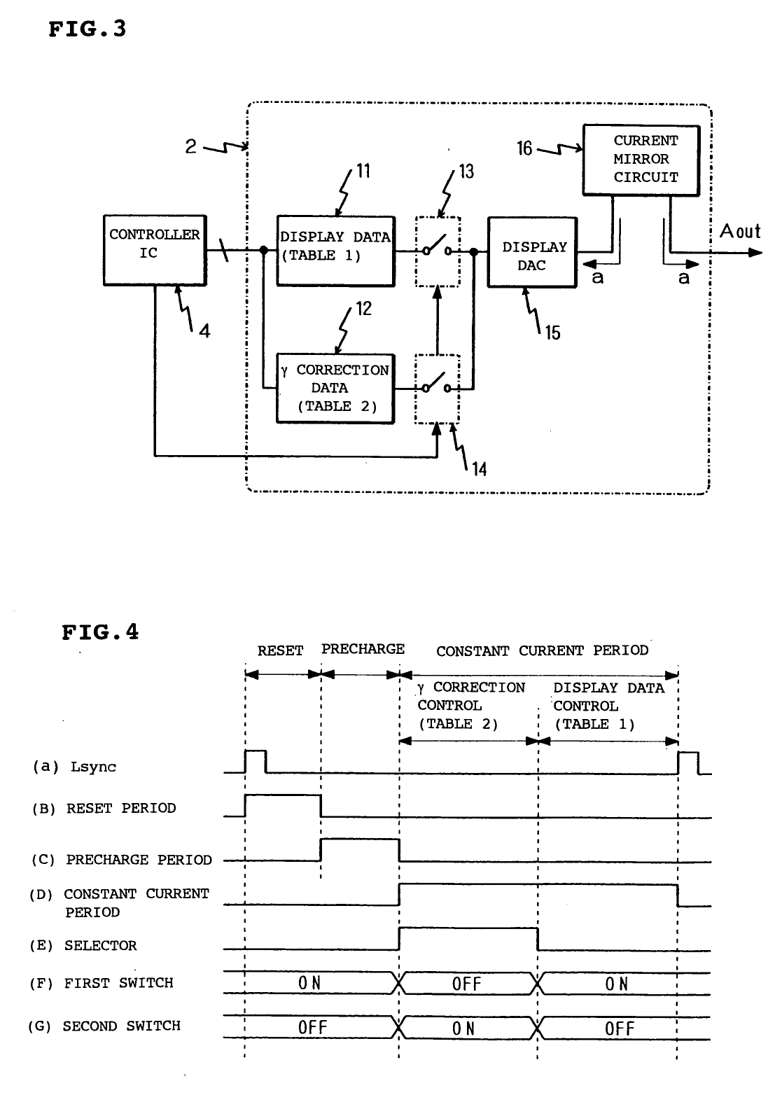

FIG. 3 shows a first embodiment according to the present invention which realizes gradation control by controlling the drive current supplied to the EL elements arranged in the display panel 1. The controller IC designated by reference numeral 4 in FIG. 3 is the same part shown in FIG. 2, and the data driver (anode line drive circuit) which is enclosed by dash lines in FIG. 3 and which is designated by reference numeral 2 is also the same part as that shown in FIG. 2.

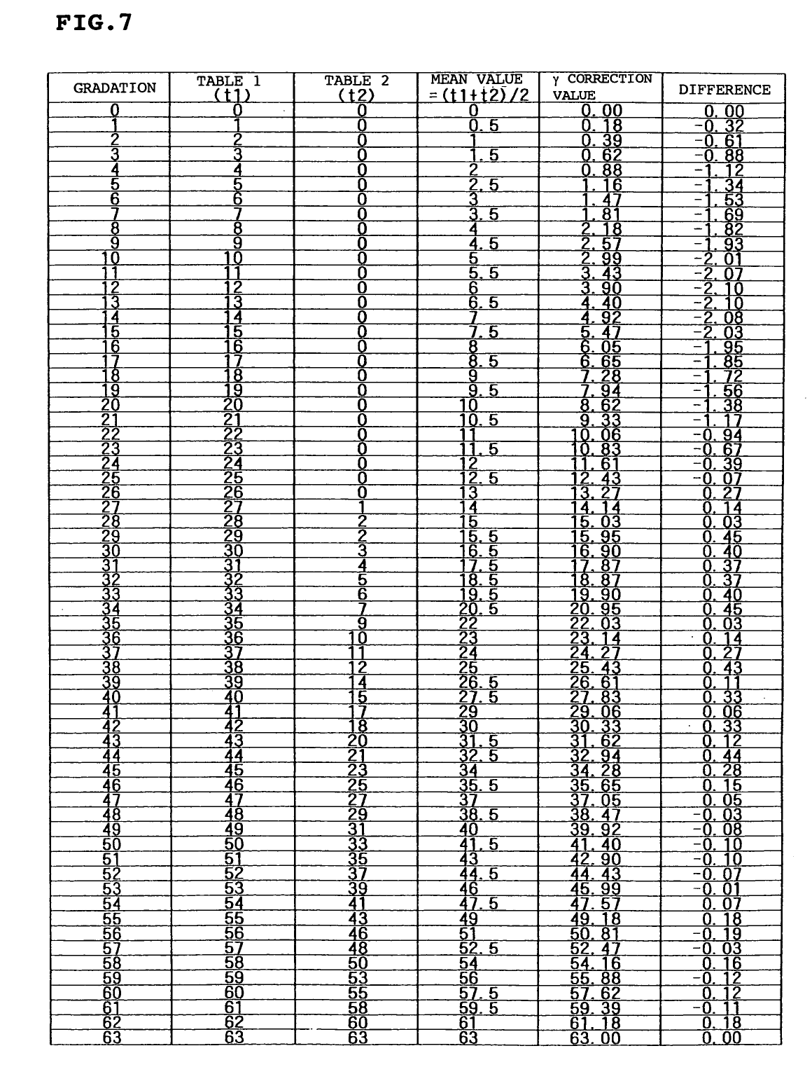

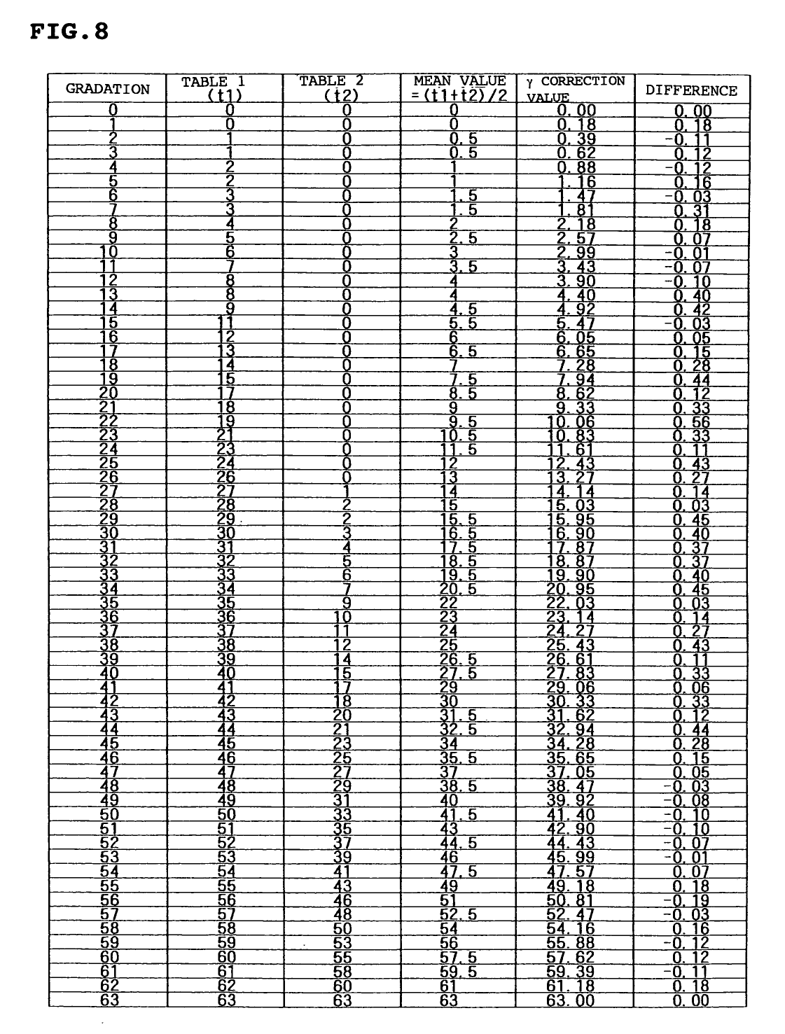

In the embodiment shown in FIG. 3, in the anode line drive circuit 2, disposed are a display data table (Table 1) designated by reference numeral 11 and a γ correction data table (Table 2) designated by reference numeral 12. A command signal corresponding to a gradation for which light emission control is to be performed is supplied from the controller IC 4 to the respective data tables 11, 12, and by this supply, intensity conversion data are read out of the respective data tables 11, 12. A specific example of the intensity conversion data in the respective data tables 11, 12 will be explained with reference to FIGS. 7 and 8 later.

The intensity conversion data read out of the display data table 11 is supplied to a display DAC 15 via a first switch 13 constituting switch means, and the intensity conversion data read out of the γ correction data table 12 is supplied to the display DAC 15 via a second switch 14 constituting switch means. The display DAC 15 operates to receive the intensity conversion data supplied via the switch means to generate a control voltage Vcon.

An absorption current a in a current mirror circuit 16 is controlled based on the control voltage Vcon generated in the display DAC 15, and thus a light emission drive current a for the EL element is outputted from the current mirror circuit 16 to Aout for the anode lines A1-An which are shown in FIG. 1 as the data lines. That is, the current mirror circuit 16 achieves the function of the respective constant current sources I1-In in the anode line drive circuit 2.

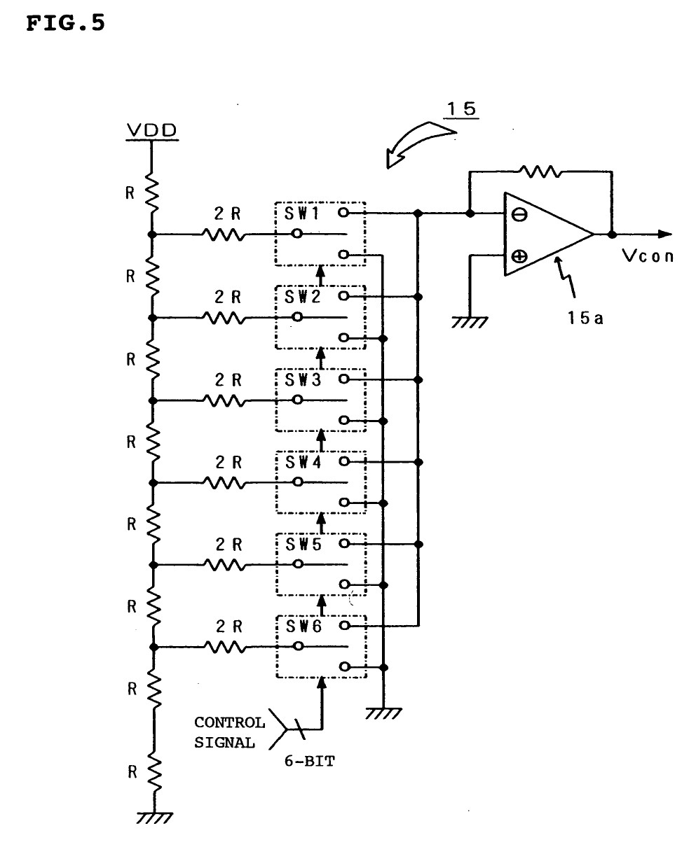

FIG. 5 shows a specific example of the display DAC 15 shown in FIG. 3. This display DAC 15 shows a current additive type DA converter as an example. That is, eight resistors R having the same resistance value are connected in series and are arranged between a power source VDD and ground, and the divided voltage potentials of respective connection points are supplied to select switches SW1-SW6 via resistors 2R which have the same resistance value. The select switches SW1-SW6 are constructed in such a way that the respective divided voltage potentials are supplied to a buffer 15a constituted by an op amp or are connected to the ground.

The ON/OFF states of the select switches SW1-SW6 are set by a control signal (a digital quantity), and analog amount (control voltage Vcon) is outputted from the buffer 15a. The output characteristic of the DAC shown in FIG. 5 is linear, and the intensity conversion data read out of the first or second data table 11, 12 shown in FIG. 3 is utilized for the control signal which performs ON/OFF control of the select switches SW1-SW6.

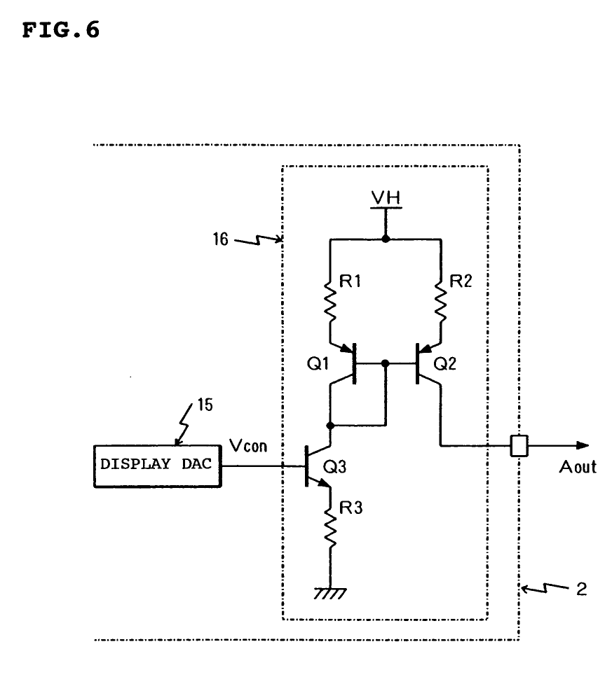

FIG. 6 shows an example of the current mirror circuit 16 whose output current is controlled based on the control voltage Vcon generated by the display DAC 15. In this current mirror circuit 16, respective emitters of PNP type transistors Q1, Q2 are connected via resistors R1, R2 which are connected to the drive voltage source VH, and the bases of the respective transistors Q1, Q2 are commonly connected. The base and collector of the transistor Q1 constituting a current control side are directly connected.

The collector of an NPN type transistor Q3 is connected to the collector of the transistor Q1, and the emitter thereof is connected to the ground via a resistor R3. The control voltage Vcon generated by the display DAC 15 is supplied to the base of the transistor Q3. Therefore, the transistor Q3 constitutes a current absorption circuit which operates by the control voltage Vcon generated by the DAC 15, and current corresponding to the value of the current absorbed by this current absorption circuit is outputted as Aout from the collector of the transistor Q2.

The combination of the transistor Q2 and the load resistor R2 constituting the current mirror circuit 16 corresponds, for example, to the constant current source 11 in the anode line drive circuit 2 shown in FIG. 2, and even other constant current sources 12-In can be realized by the combination of a transistor whose base is commonly connected similarly and a load resistor.

FIG. 4 explains operations of the current gradation control accompanied by γ correction implemented by the structure shown in FIGS. 3, 5 and 6. FIG. 4A shows a scan synchronization signal, and in this embodiment, a reset operation is implemented during a period shown in FIG. 4B in synchronization with the scan synchronization signal. This reset operation is an operation in which electrical charges accumulated in the parasitic capacitances of the respective EL elements arranged in the display panel are discharged.

In this reset operation, the scan switches Sk1-Skm in the cathode line scan circuit 3 shown in FIG. 2 are all switched to the ground side, and the drive switches Sa1-San in the anode line drive circuit 2 are also all switched to the ground side. Thus, the electrical potentials between both ends of the respective EL elements are all brought to the ground potential, and electrical charges accumulated in the parasitic capacitances of the respective EL elements are discharged.

Then, during a precharge period shown in FIG. 4C, charge current is supplied to the parasitic capacitances of the EL elements which are controlled to emit light so that the electrical potentials between both ends of the EL elements become the light emission threshold voltage Vth quickly. In this precharge period, only a cathode line which is selected for scanning is switched to the ground side via a corresponding scan switch, and a drive switch corresponding to an anode line to which an EL element, among EL elements corresponding to that cathode line, which becomes an object of light emission drive is connected is switched to the constant current source side.

Thus, charge current is supplied from the constant current sources I1-In to the parasitic capacitances of EL elements which become objects of light emission drive next, and at the end time of the precharge period shown in FIG. 4C, the terminal voltage across the EL element becomes the approximately light emission threshold voltage Vth.

Then, the precharge period shifts to a constant current supply period shown in FIG. 4D. This constant current supply period is divided into two periods, that is, a period of γ correction control and a period of display data control, as shown in FIG. 4. In this embodiment, although the periods obtained by the division are set at approximately the same length, the periods need not necessarily be the same length. Here, during the first half period for the γ correction control, the second switch 14 is turned on and the first switch 13 is turned off, by a selector signal shown in FIG. 4E outputted from the controller IC 4. Operation conditions regarding ON and OFF of the first and second switches 13, 14 implemented by the selector signal shown in FIG. 4E are shown in FIGS. 4F and 4G.

As shown in FIGS. 4F and 4G, during the first half of the constant current period, the intensity conversion data read out of theγ correction data table (Table 2) 12 is given to the display DAC 15 via the second switch 14. During the latter half of the constant current period which follows the first half, the intensity conversion data read out of the display data table (Table 1) 11 is given to the display DAC 15 via the first switch 13.

At this time, the command signal corresponding to a gradation for which light emission control is to be performed is supplied from the controller IC 4 to the display data table 11 and the γ correction data table 12 as described above, and thus the intensity conversion data corresponding to a gradation for which light emission control is to be performed is read out of the both data tables 11, 12 respectively.

During the first half of the constant current period, the intensity conversion data read out of the γ correction data table (Table 2) 12 is supplied to the display DAC 15, and the current mirror circuit supplies the drive current which is based on the control output Vcon supplied from the display DAC 15 to EL elements which are controlled to emit light. During the latter half of the constant current period which follows the first half, the intensity conversion data read out of the display data table (table 1) 11 is supplied to the display DAC 15, and the current mirror circuit supplies the drive current which is based on the control output Vcon supplied from the display DAC 15 to EL elements which are controlled to emit light.

Thus, EL elements which are controlled to emit light receive light emission control based on the intensity conversion data by the γ correction data table (Table 2) 12 during the first half of the constant current period, and receive light emission control based on the intensity conversion data by the display data table (Table 1) 11 during the latter half of the constant current period. Here, gradation grasped by human vision is supposed to be an integration amount of instantaneous light emission intensities of EL elements during the constant current period. Therefore, where the intensity conversion data by the display data table (Table 1) 1 is t1 and the intensity conversion data by the γ correction data table 12 is t2, it can be said that the gradation at this time is dependent on the mean value of t1 and t2 [=(t1+t2)/2].

FIG. 7 shows a first specific example of the above-described tables. The most left column shown in this FIG. 7 shows gradations for which light emission control is to be performed, and here, 64 gradations of “gradation 0” through “gradation 63” are provided. A right side column thereof shows the intensity conversion data stored in the display data table (Table 1), and in the example shown in this FIG. 7, data is arranged so that light emission control by linear gradation is executed corresponding to the gradations shown in the left column. A further right side column thereof shows the intensity conversion data stored in the γ correction data table (Table 2).

A further right side column thereof shows mean values of the intensity conversion data obtained by the table 1 and table 2. A further right side column thereof shows ideal γ correction values, that is, intensity values in response to the gradations. The most right column shows “differences” between the mean values and the γ correction values. Therefore, it can be said that the closer to “0” the absolute values of the “differences”, the closer to the ideal γ correction values the mean values are.

The intensity conversion data shown in Table 1 and Table 2 shown in FIG. 7, although being shown by analog quantities by numerals for convenience of explanation, are all constituted by simple integer data with two or less digits. Therefore, control operations can be simplified also without increasing the circuit scale of the display DAC 15 driven by digital data already explained. As a result, as shown by the mean values, values close to the ideal γ correction values can be obtained.

FIG. 8 shows a second specific example of the data table. The arrangement relationship shown in this FIG. 8 is the same as that shown in FIG. 7. It can be understood that according to the intensity conversion data shown in Table 1 in this FIG. 8, light emission control by linear gradation is not necessarily executed in a low gradation area, and the mean values thereof are made more close to the idealγ correction values by combination with the intensity conversion data stored in Table 2.

In this embodiment, as shown in FIG. 4, during the constant current period of each scan, at first, light emission of EL elements is controlled based on the intensity conversion data in Table 2, and then light emission of EL elements is controlled based on the intensity conversion data in Table 1. As understood referring to the intensity conversion data stored in the first and second tables shown in FIG. 7 and FIG. 8, respectively, the elements are driven to emit light at a low intensity during the first half of the constant current period, and during the latter half which follows the first half, the elements are driven to emit light at a high intensity. Thus, accuracy of light emission intensities in response to gradations can be improved.

The reason is that if light emission control is executed in the order which is reverse to the above-mentioned order, a problem occurs in that accumulation of electrical charges in the parasitic capacitances of EL elements becomes large since the elements are driven to emit light at a high intensity at first, and therefore even if the elements are to be driven to emit light at a low intensity during the latter half, the elements cannot follow the driving, whereby accuracy of light emission intensities in response to gradations is deteriorated. Thus, it is desired that the intensity conversion data stored in the data tables are set so that the value of the light emission drive current applied to EL elements during the latter half period become greater than the value of the light emission drive current applied to EL elements during the first half of the constant current period.

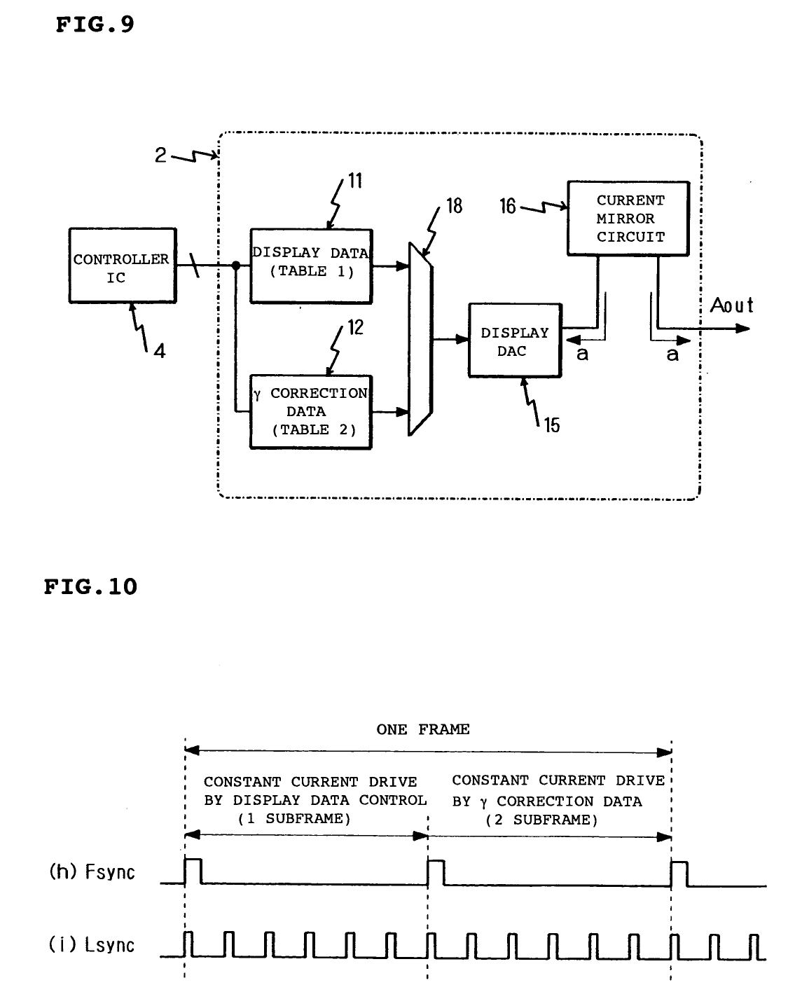

FIG. 9 shows a second embodiment according to the present invention which realizes gradation control by controlling the drive current supplied to EL elements provided as light emitting elements. Since the structure shown in FIG. 9 is basically close to that shown in FIG. 3 already explained, corresponding portions are designated by the same reference numerals/characters, and detailed explanation thereof will be omitted. In the display DAC 15 and the current mirror circuit 16 in the structure shown in FIG. 9, the circuit structures shown in FIGS. 5 and 6 already explained can be adopted as they are.

In the embodiment shown in this FIG. 9, as shown in FIG. 10, one frame period is divided into two subframes so that EL elements are driven to emit light. That is, during the first subframe, light emission drive of EL elements is executed utilizing the intensity conversion data by the display data table (Table 1) 11 already described, and during the second subframe, light emission drive of EL elements is executed utilizing the intensity conversion data by the γ correction data table (Table 2) 12. At this time, a command signal corresponding to a gradation for which light emission control is to be performed is supplied from the controller IC 4 to the respective display data table (Table 1) 11 and γ correction data table (Table 2) 12, and thus intensity conversion data corresponding to a gradation for which light emission control is to be performed are read out of both data tables 11, 12 respectively.

Reference numeral 18 in FIG. 9 shows a selector constituting switch means, and FIG. 10H and FIG. 10I show a frame synchronization signal and a scan synchronization signal, respectively. Thus, the selector 18 operates to supply the intensity conversion data which is read out of the display data table (Table 1) 11 and which corresponds to a gradation for which light emission control is to be performed to the display DAC 15 during the first subframe period shown in FIG. 10, and operates to supply the intensity conversion data which is read out of the γ correction data table (Table 2) 12 and which corresponds to a gradation for which light emission control is to be performed to the display DAC 15 during the second subframe period.

In the embodiment shown in these FIGS. 9 and 10 also, the intensity conversion data stored in the first and second tables shown in FIGS. 7 and 8 are similarly utilized, respectively. Accordingly, according to this embodiment, during one frame period, a gradation by the mean value of the intensity conversion data read out of Table 1 and Table 2 can be obtained, and as a result, similarly to the embodiment shown in FIGS. 3 and 4, gradation control accompanied by theγ correction can be realized.

In any of the embodiments described above, although organic EL elements are employed as light emitting elements, for the elements, other light emitting elements whose light intensities are dependent on the drive current can also be employed. In the embodiments shown in FIG. 3 and FIG. 9, although two tables shown by Table 1 and Table 2 are utilized, three or more tables can also be utilized. In this case, in the embodiment shown in FIG. 3, the constant current period shown in FIG. 4 is equally divided corresponding to the number of tables so that light emission control is executed utilizing the intensity conversion data read out of the respective tables during respective periods.

In the embodiment shown in FIG. 9, in the case where the above-mentioned three or more tables are utilized, one frame period shown in FIG. 10 is time-divided by the number of tables to make subframes, so that light emission control is executed utilizing the intensity conversion data read out of the respective tables for each subframe. In this case, plural frames may be treated as unit frames, and these plural frame periods may be time-divided to give respective subframes, so as to execute gradation control similarly.

1. A drive device of a passive matrix type light emitting display panel comprising a plurality of data lines and a plurality of scan lines which intersect one another and light emitting elements which are respectively connected between the respective data lines and scan lines at intersection positions between the respective data lines and scan lines, characterized by being constructed in such a way that one scan period is time-divided into a plurality of periods, that a drive current supplied to the light emitting elements is controlled for each of the plural periods to execute light emission control of the light emitting elements for each of the periods, and that gradation control including γ correction is performed by a mean value of light emission intensities of the light emitting elements during the one scan period.

2. The drive device of the light emitting display panel according to claim 1, characterized by being constructed in such a way that one scan period is time-divided into two periods, and that light emission control by linear gradation is executed during one period of the two periods.

3. The drive device of the light emitting display panel according to claim 2, characterized in that the two periods are set to equal periods.

4. A drive device of a passive matrix type light emitting display panel comprising a plurality of data lines and a plurality of scan lines which intersect one another and light emitting elements which are respectively connected between the respective data lines and scan lines at intersection positions between the respective data lines and scan lines, characterized by being constructed in such a way that for each of plural frame periods or of plural subframe periods, a drive current supplied to the light emitting elements is controlled to execute light emission control of the light emitting elements for each said period, and that gradation control including γ correction is performed by a mean value of light emission intensities of the light emitting elements during the plural frame periods or the plural subframe periods.

5. The drive device of the light emitting display panel according to claim 4, characterized by being constructed in such a way that one frame period is divided into two subframe periods, and that light emission control by linear gradation is executed during one period of the two subframe periods.

6. The drive device of the light emitting display panel as set forth in any one of claims 1 to 5, characterized by comprising a DAC which determines a current value supplied to the data lines in order to drive the light emitting elements for light emission, at least two data tables for supplying intensity conversion data to the DAC based on a gradation for which light emission control is to be performed, and switch means for alternatively supplying the intensity conversion data provided from the at least two data tables to the DAC, wherein mutually different intensity conversion data in response to a gradation for which light emission control is to be performed are stored in the at least two data tables respectively.

7. The drive device of the light emitting display panel according to claim 6, characterized in that the intensity conversion data by which light emission control by linear gradation can be executed are stored in one data table of the at least two data tables.

8. The drive device of the light emitting display panel according to any one of claims 1 to 5, characterized in that the light emitting elements constituting the light emitting display panel are organic EL elements in which an organic material is employed in a light emitting layer.

9. The drive device of the light emitting display panel according to claim 6, characterized in that the light emitting elements constituting the light emitting display panel are organic EL elements in which an organic material is employed in a light emitting layer.

10. The drive device of the light emitting display panel according to claim 7, characterized in that the light emitting elements constituting the light emitting display panel are organic EL elements in which an organic material is employed in a light emitting layer.

11. A drive method of a passive matrix type light emitting display panel comprising a plurality of data lines and a plurality of scan lines which intersect one another and light emitting elements which are respectively connected between the respective data lines and scan lines at intersection positions between the respective data lines and scan lines, characterized in that one scan period is time-divided into a plurality of periods, that intensity conversion data from data tables which are set corresponding to said periods are obtained during each period, and that a process in which a light emission drive current based on the obtained intensity conversion data is added to the light emitting elements is executed sequentially, so that gradation control including γ correction is realized by a mean value of light emission intensities by the light emitting elements during the one scan period.

12. The drive method of the light emitting display panel according to claim 11, characterized in that the intensity conversion data are stored in the data tables so that the value of the light emission drive current added to the light emitting elements is greater during a latter period than the value of the light emission drive current added to the light emitting elements during a first period of the time-divided one scan period.

13. A drive method of a passive matrix type light emitting display panel comprising a plurality of data lines and a plurality of scan lines which intersect one another and light emitting elements which are respectively connected between the respective data lines and scan lines at intersection positions between the respective data lines and scan lines, characterized in that for each of plural frame periods or of plural subframe periods, intensity conversion data from data tables which are set corresponding to said periods are obtained, and that a process in which a light emission drive current based on the obtained intensity conversion data is added to the light emitting elements is executed sequentially, so that gradation control including γ correction is realized by a mean value of light emission intensities by the light emitting elements during the plural frame periods or plural subframe periods.
